(19) United States
(12) Patent Application Publication
(10) Pub. No.: US 2004/0261109 A1
(43) Pub. Date: Dec. 23, 2004

(54) Network-connectable controller device

(76) Inventor: Atsushi Takagi, Daito-shi (JP)

Correspondence Address: CROWELL & MORING LLP, INTELLECTUAL PROPERTY GROUP, P.O. BOX 14300, WASHINGTON, DC, 20044-4300, US

(21) Appl. No.: 10/873,164

(22) Filed: Jun. 23, 2004

(30) Foreign Application Priority Data
Jun. 23, 2003 (JP) 2003-177504

(51) Int. Cl. H04N 7/18

(52) U.S. Cl. 725/74; 725/80; 725/78

(57) ABSTRACT

A controller device of one manufacturer discriminates whether or not SDD data of a newly network-connected target device is SDD data of target device of the same manufacturer, if the number of records in a table in the controller device is already at maximum value. If this discrimination indicates that the SDD data of the newly network-connected target device is SDD data of target device of the same manufacturer, then the controller device deletes, from records stored in the table, a record having ID code of a different manufacturer, and stores, in the table, a record based on and edited from the SDD data of the newly network-connected target device. Thereby, it becomes possible for the controller device to store, by priority in the table, DCM code units storing control programs of target devices of the same manufacturer. Thus, target devices of the same manufacturer can be controlled by priority, so that it is possible to secure unique interrelated functions among network-connected devices of the same manufacturer.

### BACKGROUND OF THE INVENTION

1. Field of the Invention

The present invention relates a network-connectable controller device, and more particularly to a controller device, such as FAV (Full AV Device) conforming to the HAVi (Home Audio Video interoperability) standard, to control target devices such as BAV (Base AV Device) also conforming to the HAVi standard.

2. Description of the Related Art

A standard called HAVi (Home Audio Video interoperability) is known as a standard network specification to interconnect home digital AV (Audio Visual) devices. According to this HAVi standard, devices to be connected to a network are classified into controller devices, such as FAV (Full AV Device), having a function to control the state of other connected devices, and into target devices, such as BAV (Base AV Device), being controlled by the controller devices.

When a target device is newly connected to a network having connected thereto a controller device such as described above, it is required for the controller device to receive SDD (Self Describing Device) data from the newly connected target device, and to store, in a table in a memory thereof, a control module such as DCM (Device Control Module) contained in a DCM code unit in the SDD data. However, in the case where the network has many target devices to be controlled, there is a possibility that the table in the memory may be filled to its full capacity. A conventional controller device, in such case, is designed either to reject storing the control module of the newly connected target device, or to delete its oldest control module out of control modules of target devices stored in the table thereof, and store the control module of the newly connected target device in place of the deleted control module.

Meanwhile, Japanese Laid-open Patent Publication 2002-324018 discloses a portable terminal such that when profile data is sent from a car navigation device, the portable terminal compares the size of the sent profile data with unused area of a memory thereof, and that in the case where the unused area of the memory is smaller than the size of the sent profile data, the portable terminal deletes a group of profile data with low use frequency in the memory.

In the case of the above-described conventional controller device, which either rejects storing the control module of the newly connected target device, or deletes control module(s) of target devices stored in the table thereof in order of priority from oldest to newest, and stores the control module of the newly connected target device in place of the deleted control module(s), it is not possible to control, by priority, target devices of the same manufacturer as the manufacturer of the controller device (hereafter the term “same manufacturer” being used to mean that each manufacturer of each target device to be controlled by the controller device is the same as the manufacturer of the controller device). This causes a problem that it is not possible to secure unique interrelated functions among network-connected devices of the same manufacturer. Such problem cannot be solved at all by the technology disclosed in the above-referred Japanese Laid-open Patent Publication 2002-324018.

### SUMMARY OF THE INVENTION

An object of the present invention is to provide a network-connectable controller device which can control, by priority, target devices of the same manufacturer, thereby making it possible to secure unique interrelated functions among network-connected devices of the same manufacturer.

According to the present invention, this object is achieved by a network-connectable controller device which conforms to HAVi (Home Audio Video interoperability) standard, and which is connectable, via an IEEE 1394 serial bus, to target devices conforming to the HAVi standard, the controller device comprising: a memory to store SDD (Self Describing Device) data including control information and profile data of the controller device as a device conforming to the HAVi standard, and further to store a group of HAVi software including a DCM (Device Control Module) manager to install, from each target device connected to the controller device via the IEEE 1394 serial bus, a DCM code unit which is a file storing a program to control the each target device, and still further to store a table storing records including at least DCM code units in SDD data sent from the target devices; receiving means to receive the SDD data sent from the each target device; new SDD data discriminating means to discriminate whether or not the SDD data received by the receiving means from the each target device is SDD data of a newly connected target device; determining means to determine whether or not the number of records in the table is already at maximum value if the discrimination by the new SDD data discriminating means indicates that the SDD data received from the each target device is SDD data of the newly connected target device; and control means to exercise control to discriminate whether or not the SDD data of the newly connected target device is SDD data of a target device of the same manufacturer as that of the controller device (hereinafter the term “same manufacturer” being used to mean that each manufacturer of each target device to be controlled by the controller device is the same as the manufacturer of the controller device) if the determination by the determining means indicates that the number of records in the table is already at the maximum value, and to further exercise control to delete, from the records stored in the table, a record having ID code of a manufacturer different from the manufacturer of the controller device (hereinafter the term “different manufacturer” being used to mean that each manufacturer of each target device to be controlled by the controller device is different from the manufacturer of the controller device) if the discrimination indicates that the SDD data of the newly connected target device is SDD data of a target device of the same manufacturer, and to still further exercise control to store, in the table, a record based on and edited from the SDD data of the newly connected target device.

In this configuration, it is determined by the determining means whether or not the number of records in the table is already at the maximum value if the SDD data received from each target device is SDD data of a newly connected target device. If this determination indicates that the number of records in the table is already at the maximum value, then the control means discriminates whether or not the SDD data of the newly connected target device is SDD data of target device of the same manufacturer. If this discrimination indicates that the SDD data of the newly connected target device is SDD data of target device of the same manufacturer, then the control means deletes, from the records stored in the table, a record having ID code of a different manufacturer, and stores, in the table, a record based on and edited from the SDD data of the newly connected target device. Thereby, it becomes possible for the controller device to store, by priority in the SDD data table, DCM code units storing control programs of target devices of the same manufacturer. Thus, target devices of the same manufacturer can be controlled by priority, so that it is possible to secure unique interrelated functions among network-connected devices of the same manufacturer.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic electrical block diagram showing a controller device according to an embodiment of the present invention and a target device to be controlled by the controller device;

FIG. 2 is a list showing SDD data stored in a configuration ROM in a memory of the target device;

FIG. 3 is an SDD data table in the memory of the controller device, showing an example of records stored therein;

FIG. 4 is a schematic flow chart showing a process of storing the records in the SDD data table; and

FIG. 5 is a schematic drawing showing various target devices which are to be controlled by the controller device, and are OSD-displayed on a display unit of the controller device.

### DESCRIPTION OF THE PREFERRED EMBODIMENTS

An embodiment of the present invention will be described hereinafter with reference to the drawings.

A controller device according to the present embodiment is a device such as FAV (Full AV Device) conforming to the HAVi (Home Audio Video interoperability) standard, and is, for example, a digital television which can receive digital data from target devices and display the digital data as video images. On the other hand, target devices to be controlled by the controller device according to the present embodiment are devices such as BAV (Base AV Device) conforming to the HAVi standard. One example of the target devices is a DVD (Digital Versatile Disc) player which can reproduce signals such as video signals recorded on a disc and send them to the controller device.

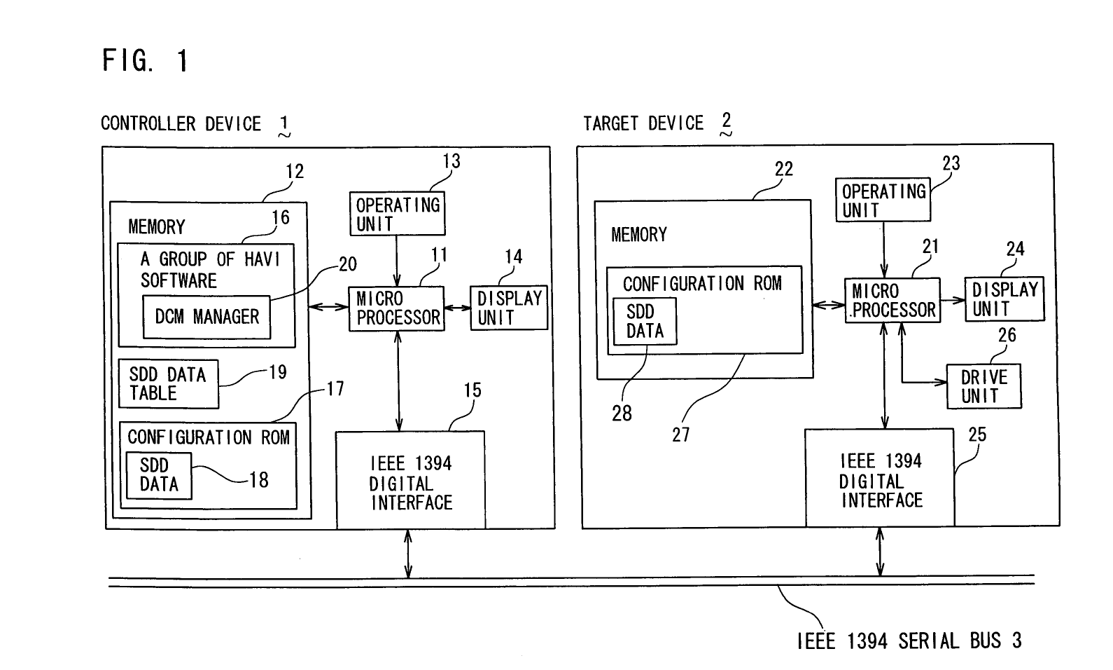

FIG. 1 shows an electrical block diagram of a controller device 1 according to an embodiment of the present invention and each target device 2 to be controlled by the controller device 1. Although it is premised that a plurality of target devices can be network-connected to the controller device 1, FIG. 1 shows one target device 2 for the sake of simplicity. The controller device 1 is connected to each target device 2 via an IEEE 1394 serial bus (hereafter referred to as simply “bus”) 3, and comprises a micro processor 11 to control the whole system. The micro processor 11 functions as new SDD data discriminating means, determining means and control means as well.

The controller device 1 further comprises: a memory 12 to store various data; an operating unit 13 to input various commands; a display unit 14 to display e.g. video data sent from each target device 2; and an IEEE 1394 digital interface (hereafter referred to as simply “interface”) 15 (receiving means) to send and receive various data to and from each target device 2 via the bus 3.

The memory 12 is provided to store: a group of HAVi software 16 comprising various software elements to form HAVi architecture; a configuration ROM (read-only memory) 17 storing e.g. various information about the controller device 1; an SDD (Self Describing Device) data table 19 storing such records that each contains at least a DCM (Device Control Module) code unit in SDD data sent from each target device 2; and so on. The DCM code unit is a file storing program(s) to control device(s). The group of HAVi software 16 includes: a DCM manager 20 that is a program to install and uninstall DCM code unit(s); and various software elements such as CMM (Communication Media Manager), not shown, that is a program to abstract communication protocol to communicate with other network-connected devices. The configuration ROM 17 stores SDD data 18 including control information and profile data of the controller device 1 as a device conforming to the HAVi standard.

Similarly as for the controller device 1, each above-described target device 2 comprises: a micro processor 21; a memory 22 storing a configuration ROM 27; an operating unit 23, a display unit 24 and an interface 25, wherein the configuration ROM 27 of the memory 22 stores SDD data 28. However, in contrast to the controller device 1, the memory 22 of each target device 2 does not store a group of HAVi software or an SDD data table. Besides, each target device 2 comprises a drive unit 26 to perform various operations according to the kind of device.

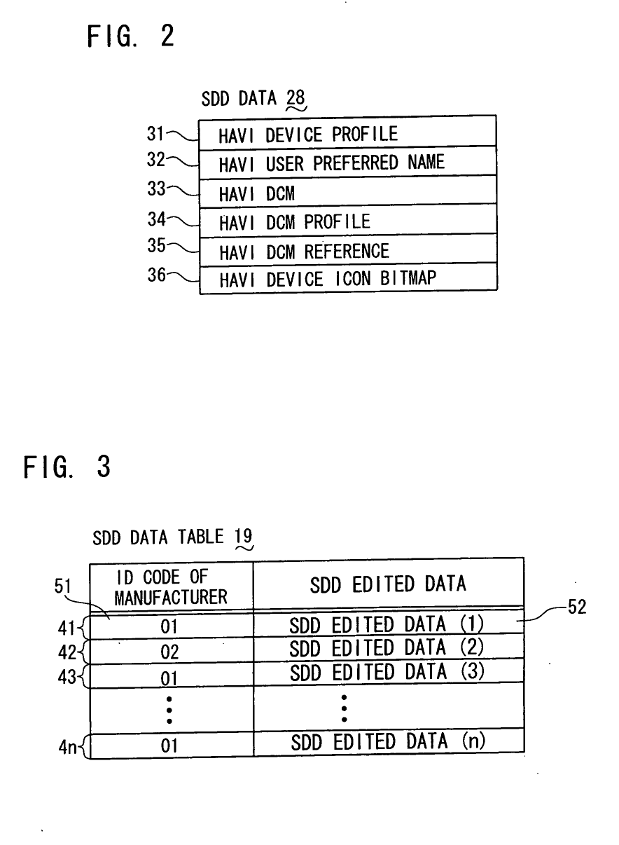

FIG. 2 shows various data contained in the SDD data 28 stored in the configuration ROM 27 in the memory 22 of each target device 2. In FIG. 2, HAVi Device Profile 31 is data describing each device class and vendor information of each target device 2 as well as describing capabilities of each target device 2 as a device conforming to the HAVi standard. HAVi User Preferred Name 32 is a name of the device freely named by a user. HAVI DCM 33 is area data corresponding to the above-described DCM code unit. HAVi DCM Profile 34 and HAVi DCM Reference 35 are attribute information and URL (Uniform Resource Locator) information, respectively, of the HAVi DCM 33. HAVi Device Icon Bitmap 36 is icon data to represent the sort of the device which conforms to the HAVi standard.

Next, referring to FIG. 3, the records stored in the SDD data table 19 as described above with reference to FIG. 1 will be described below. The SDD data table 19 stores records 41 to 4n that are based on and edited from the SDD data 28 sent from respective target devices 2 network-connected to the controller device 1. Each of these records 41 to 4n comprises: ID code 51 of a manufacturer of each target devices 2 sending each SDD data 28 on which each record is based; and each of SDD edited data (1) to (n) (hereinafter referred to collectively as “SDD edited data 52”) which is data based on and edited from each SDD data 28. Each SDD edited data 52 contains at least the DCM code unit (which is data corresponding to the HAVi DCM 33 in FIG. 2) in each SDD data on which each SDD edited data 52 is based. It is to be noted that each SDD edited data 52 may be the entirety of each SDD data 28 on which each SDD edited data 52 is based.

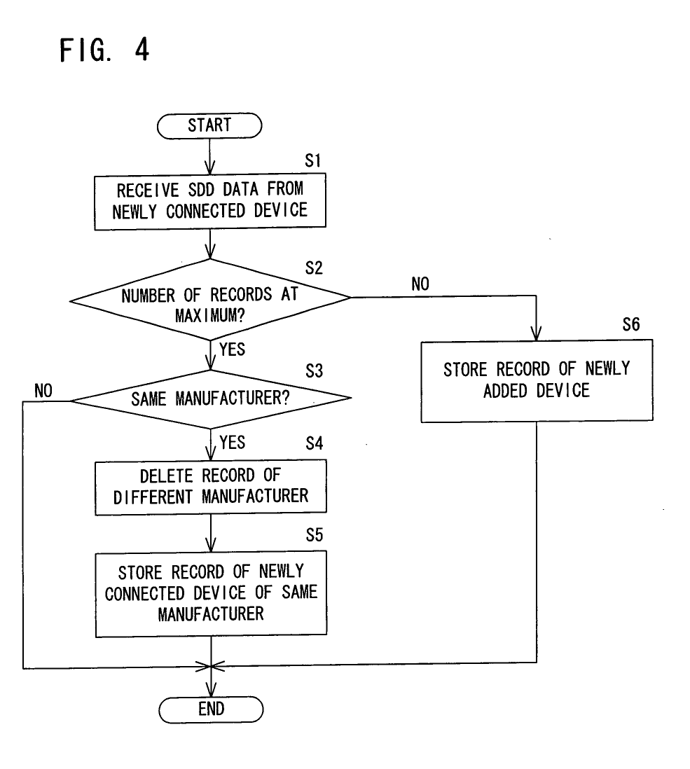

Hereinafter, referring to the flow chart of FIG. 4, it will be described how the records are stored in the above-described SDD data table 19. When a target device 2 is newly connected to the bus 3, a bus reset occurs, and the newly connected target device 2 sends SDD data 28 (refer to FIG. 1) in configuration ROM 27 thereof to each network-connected device on the bus 3. When the micro processor 11 of the controller device 1 receives the SDD data 28 via the interface 15, the micro processor 11 discriminates whether or not the received SDD data 28 is the SDD data 28 of the newly connected target device 2. If this discrimination indicates that the received SDD data 28 is the SDD data 28 of the newly connected target device 2, then the micro processor 11 determines whether or not the number of records in the SDD data table 19 is already at the maximum value (S1 and S2). If this determination indicates that the number of records is already at the maximum value (YES in S2), then the micro processor 11 discriminates whether or not the SDD data 28 of the newly connected target device 2 is SDD data 28 of target device 2 of the same manufacturer as that of the controller device 1 having the micro processor 11 (S3) (hereafter the term “same manufacturer” being used to mean that each manufacturer of each target device to be controlled by the controller device is the same as the manufacturer of the controller device).

If the above-described discrimination indicates that the SDD data 28 of the newly connected target device 2 is SDD data of target device of the same manufacturer (YES in S3), then the micro processor 11 deletes, from records stored in the SDD data table 19, a record having ID code of a manufacturer different from the manufacturer of the controller device 1 (S4) (hereinafter the term “different manufacturer” being used to mean that each manufacturer of each target device to be controlled by the controller device is different from the manufacturer of the controller device). For example, if the SDD data table 19 has such records 41 to 4n therein as shown in FIG. 3, and if the ID code of the manufacturer of the controller device 1 is “01”, then the micro processor 11 deletes the record 42 having ID code of “02” that is ID code of a different manufacturer. The micro processor 11 then stores, in the SDD data table 19, a record based on and edited from the SDD data 28 of the newly connected target device 2 of the same manufacturer (S5).

On the other hand, if the above-described determination process S2 indicates that the number of records in the SDD data table 19 is still below the maximum value (NO in S2), the micro processor 11 additionally stores, in the SDD data table 19, the record based on and edited from the SDD data 28 of the newly added target device 2 (S6).

As described above, if the SDD data 28 of the newly connected target device 2 is SDD data 28 of a target device 2 of the same manufacturer as the manufacturer of the controller device 1 in the case where the number of records in the SDD data table 19 is already at the maximum value, then a record corresponding to the SDD data 28 of the newly connected target device 2 of the same manufacturer is stored in the SDD data table 19, while a record having an ID code of a different manufacturer is deleted from the records stored in the SDD data table 19. Thereby, it becomes possible for the controller device 1 to store, by priority in the SDD data table 19, the SDD edited data 52 (refer to FIG. 3) storing a control program of the target device 2 of the same manufacturer. Thus, target devices 2 of the same manufacturer as that of the controller device 1 can be controlled by priority, so that a network having the controller device 1 and the target devices 2 of the same manufacturer as a core part thereof can be built. Accordingly, troubles caused by lack of compatibility between devices of different manufacturers can be made unlikely to occur. Furthermore, since functions of network-connected devices of the same manufacturer can be secured by priority, it is possible to secure unique interrelated functions among the network-connected devices of the same manufacturer.

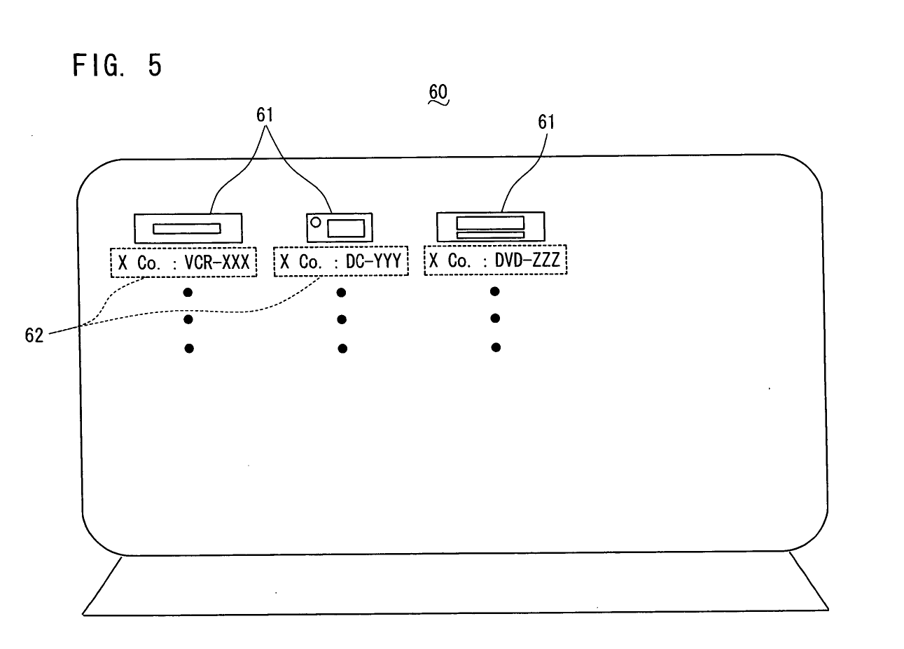

Since a network having the controller device 1 and the target devices 2 of the same manufacturer as a core part thereof can be built as described above, the following effects can be achieved in the case where the controller device 1 is a digital television as an example. Specifically, assuming that target devices 2 to be controlled by the digital television are OSD (on-screen display) displayed on a screen (corresponding to the display unit 14 in FIG. 1) of the digital television, it is possible as shown in FIG. 5 to display, on a screen 60, icons 61 of respective target devices 2 as well as product codes 62, regarding the respective target devices, which have a name of the same manufacturer as that of the controller device 1 (digital television). Thereby, the name of the manufacturer of the controller device 1 (digital television) as well as the products of the same manufacturer can appeal to users.

It is to be noted that the present invention is not limited to the above-described embodiment, and various modifications are possible. In the embodiment, for example, a record corresponding to a newly connected target device of the same manufacturer is stored in an SDD data table while deleting a record having ID code of a different manufacturer from the records in the table, if the number of records in the table is already at the maximum value and if the manufacturer of the newly connected target device is the same as the manufacturer of the controller device. However, instead it can also be so designed to store, in an SDD data table, a record corresponding to a newly connected target device, if the manufacturer of the newly connected target device is the same as the manufacturer of the controller device, regardless of whether or not the number of records in the table is at the maximum value.

It is also possible to so design that a record corresponding to a target device of the same manufacturer as the manufacturer of the controller device is stored by priority in an SDD data table as described above, if a user selects the above-described function, using the operating unit of the controller device. Furthermore, although the above-described embodiment illustrates a case where the network-connectable controller device is a controller device which can be connected to an IEEE 1394 serial bus, the present invention can also be applied to controller devices which can be connected to serial buses, such as USB (Universal Serial Bus), other than the IEEE 1394 serial bus.

This application is based on Japanese patent application 2003-177504 filed Jun. 23, 2003 in Japan, the contents of which are hereby incorporated by reference.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

What is claimed is:

1. A network-connectable controller device which conforms to HAVi (Home Audio Video interoperability) standard, and which is connectable, via an IEEE 1394 serial bus, to target devices conforming to the HAVi standard, the controller device comprising:
a memory to store SDD (Self Describing Device) data including control information and profile data of the controller device as a device conforming to the HAVi standard, and further to store a group of HAVi software including a DCM (Device Control Module) manager to install, from each target device connected to the controller device via the IEEE 1394 serial bus, a DCM code unit which is a file storing a program to control the each target device, and still further to store a table storing records including at least DCM code units in SDD data sent from the target devices;
receiving means to receive the SDD data sent from the each target device;
new SDD data discriminating means to discriminate whether or not the SDD data received by the receiving means from the each target device is SDD data of a newly connected target device;
determining means to determine whether or not the number of records in the table is already at maximum value if the discrimination by the new SDD data discriminating means indicates that the SDD data received from the each target device is SDD data of the newly connected target device; and
control means to exercise control to discriminate whether or not the SDD data of the newly connected target device is SDD data of a target device of the same manufacturer as that of the controller device if the determination by the determining means indicates that the number of records in the table is already at the maximum value, and to further exercise control to delete, from the records stored in the table, a record having ID code of a manufacturer different from the manufacturer of the controller device if the discrimination indicates that the SDD data of the newly connected target device is SDD data of a target device of the the same manufacturer as that of the controller device, and to still further exercise control to store, in the table, a record based on and edited from the SDD data of the newly connected target device.

2. The network-connectable control device according to claim 1, wherein each of the records stored in the table in the memory contains ID code of the manufacturer of the each target device from which the SDD data is sent.

3. The network-connectable control device according to claim 1, wherein, if the determination by the determining means indicates that the number of records in the table is still below the maximum value, the control means exercises control to additionally store, in the table, a record based on and edited from the SDD data of the newly connected target device.

4. The network-connectable control device according to claim 3, wherein each of the records stored in the table in the memory contains ID code of the manufacturer of the each target device from which the SDD data is sent.
